(19) United States
(12) Patent Application Publication
(10) Pub. No.: US 2005/0247494 A1
(43) Pub. Date: Nov. 10, 2005

(54) Electronic scale and body fat measuring apparatus

(76) Inventor: James G. Montagnino, St. Charles, IL (US)

Correspondence Address: MCDERMOTT WILL & EMERY LLP, 600 13TH STREET, N.W., WASHINGTON, DC, 20005-3096, US

(21) Appl. No.: 11/037,476

(22) Filed: Jan. 19, 2005

Related U.S. Application Data
(60) Provisional application No. 60/537,008, filed on Jan. 20, 2004.
(60) Provisional application No. 60/537,007, filed on Jan. 20, 2004.
(60) Provisional application No. 60/631,900, filed on Dec. 1, 2004.

(51) Int. Cl. G01G 13/00

(52) U.S. Cl. 177/60

(57) ABSTRACT

An electronic scale and body fat measuring apparatus is provided which has particular applicability to electronic scales and body fat measuring devices for medical and personal use. The electronic scale suggests a goal weight and/or goal body fat percentage or optionally allows the user to enter their own target goals. The scale displays a comparison of their current weight and goal weight and/or current body fat percentage and goal body fat percentage.

### CROSS-REFERENCE TO PROVISIONAL APPLICATIONS

This application relates to and claims priority from U.S. Provisional Application Ser. No. 60/537,008, filed Jan. 20, 2004; U.S. Provisional Application Ser. No. 60/537,007, filed Jan. 20, 2004; and U.S. Provisional Application Ser. No. 60/631,900, filed Dec. 1, 2004, the disclosures of each are hereby incorporated in their entirety by reference.

### FIELD OF THE INVENTION

The present invention relates to an electronic scale and body fat measuring apparatus. The present invention has particular applicability to electronic scales and body fat measuring devices for medical and personal use.

### BACKGROUND ART

Electronic scales for personal and medical use are well-known. Also well-known are electronic scales which measure body fat using bioelectrical impedance. Typically, a user enters basic personal information, such as gender, age and height, and steps on the scale barefoot such that their feet contact a set of electrodes. Electrical signals from load cells in the scale are converted into a weight value and displayed by the scale, while bioelectrical impedance is measured in a conventional manner via the electrodes and converted into a body fat percentage value and displayed by the scale. Examples of conventional bioelectrical impedance apparatuses are shown in U.S. Pat. No. 6,618,616 to Iijima et al.; and U.S. Pat. No. 6,552,553 to Shoji et al., each of these patents incorporated herein by reference in its entirety.

There exists a need in the art for an electronic scale which allows the user to set a goal weight for themselves and compare their goal weight to their current weight. There also exists a need for an electronic scale which provides a suggested target weight and/or body fat percentage to the user. Further, there exists a need for an electronic scale and body fat measuring apparatus which provides a suggested target weight and/or body fat percentage to the user, and automatically sets a goal weight and steps towards the goal weight based on stored reference data.

### SUMMARY OF THE INVENTION

An advantage of the present invention is an electronic scale which allows the user to enter a goal weight for themselves, and displays the goal weight, a previous weight, and the difference between the goal weight and the current measured weight.

An additional advantage of the present invention is an electronic scale/body fat meter that allows the user to compare their weight, body fat percentage, body water, etc. against known values stored in the memory of the scale with or without the user's weight being displayed.

Another advantage of the present invention is an electronic scale which allows the user to enter a goal weight for themselves, and displays a comparison of the goal weight, a previous weight, and the difference between the goal weight and the current measured weight with or without the current weight or goal weight being displayed.

Additional advantages and other features of the present invention will be set forth in part in the description which follows and in part will become apparent to those having ordinary skill in the art upon examination of the following or may be learned from the practice of the invention. The advantages of the invention may be realized and obtained as particularly pointed out in the appended claims.

According to the present invention, the foregoing and other advantages are achieved in part by a scale comprising a platform for supporting the weight of a user. A load cell is present for receiving the weight of the user when the user steps on the platform, and for generating a signal responsive to the weight of the user. The scale includes a processor for calculating a current weight of the user responsive to the signal from the load cell. An input unit is operatively connected to the processor for manually entering a goal weight and a display unit is operatively connected to the processor. The processor is for storing the goal weight and the current weight and for causing the display unit to display the stored goal weight and the current weight. Alternatively, the processor is for storing the goal weight and the current weight and for causing the display unit to display a difference between the current weight and the goal weight.

Another aspect of the present invention is a scale further including a memory device for storing reference data relating suggested goal weights to personal data. The input unit is for entering personal data of the user. The processor is for determining a suggested goal weight for the user based on the reference data and the personal data of the user. The processor is for storing the determined suggested goal weight as the goal weight when the user does not enter the goal weight using the input unit.

A still further aspect of the present invention is a scale further including a bioelectrical impedance measuring device for measuring a bioelectrical impedance of the user when the user steps on the scale. The processor is for calculating a current body fat percentage of the user based on the measured bioelectrical impedance. Reference data is stored in the memory device and includes data relating suggested goal body fat percentages to the personal data. The processor is for determining a suggested goal body fat percentage based on the reference data and the personal data of the user, and for storing the determined suggested goal body fat percentage as a goal body fat percentage. The processor is for causing the display unit to display the current body fat percentage and the goal body fat percentage. In alternative embodiments, the processor is for calculating a difference between the current body fat percentage and the goal body fat percentage, and causing the display unit to display the difference between the current body fat percentage and the goal body fat percentage without displaying the user's current body fat percentage or current weight.

Additional advantages of the present invention will become readily apparent to those skilled in this art from the following detailed description, wherein only exemplary embodiments of the present invention are shown and described, simply by way of illustration of the best mode contemplated for carrying out the present invention. As will be realized, the present invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

The following detailed description of the embodiments of the present invention can best be understood when read in conjunction with the following drawings, in which the various features are not necessarily drawn to scale but rather are drawn as to best illustrate the pertinent features, and in which like reference numerals are employed throughout to designate similar features.

FIG. 1 is a flow chart showing a series of actions taken for a required measurement on an electronic scale in accordance with one example of the present invention;

FIG. 2a shows the front view of a conventional scale for measuring weight;

FIG. 2b shows the front view of a conventional scale for measuring weight and body fat;

FIG. 3 is a block diagram of a conventional control circuit;

FIG. 4 is a flow chart showing a series of actions taken for required measurements on an electronic scale in accordance with another example of the present invention;

FIG. 5 shows a front view of a display portion of an electronic scale according to one example of the present invention;

FIG. 6 shows a front view of a display portion of an electronic scale according to another example of the present invention; and

FIG. 7 shows a table with body fat ranges for standard adults.

### DESCRIPTION OF THE INVENTION

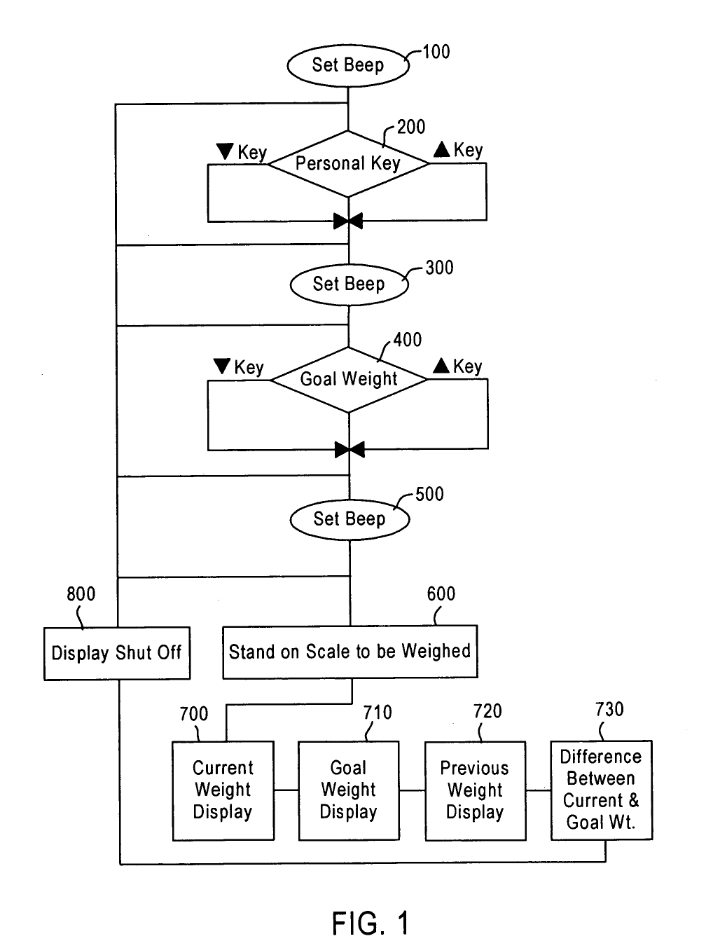

According to one embodiment of the present invention, as illustrated in the block diagram of FIG. 1, the user of the inventive electronic scale can enter a goal weight, which will then be stored by the scale and displayed along with their actual measured weight. In the embodiment shown in FIG. 1, the user sets a goal weight, then steps on the scale. Specifically, in FIG. 1, the user will initiate the process by selecting (Step 100) a set button on the scale which will notify the user with one or more beeping sounds from a buzzer. Since the scale stores personal data for a plurality of users, the user can select (Step 200) their own personal user number by pressing the upward or downward buttons. Once a desired user preference number is chosen, the user will set their selection by pressing a set button (Step 300) and will be notified with one or more beeping sounds. Next, the user will enter (Step 400) a goal weight and set (Step 500) the goal weight which will then be stored by the scale and displayed. In the embodiment shown in FIG. 1, after the user sets a goal weight, he/she steps (Step 600) on the scale. The user's current weight is measured (Step 600), stored and displayed (Step 700) along with the goal weight (Step 710). The scale cycles between displaying goal weight, the last weight (i.e., the user's previously measured weight) and the difference between the goal weight and the current weight while constantly displaying the current weight. The display on the scale will automatically shut off after a specified period of time of inactivity (Step 800).

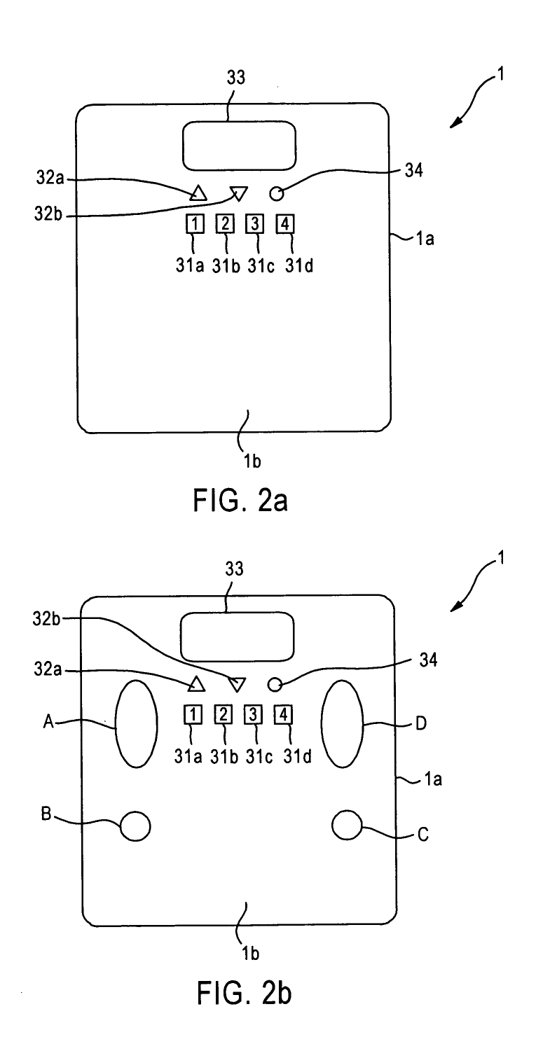

The inventive electronic scale performs the above sensing and calculations electronically using conventional hardware such as, for example, a load cell, a microprocessor and an addressable memory device. As a non-limiting example, FIG. 2a illustrates a conventional electronic scale 1 that is equipped with a weight scale 1a for measuring a user's weight, in which the present invention can be embodied. A display 33, and a personal data-inputting or setting button 34 are arranged on the upper surface 1b of the electronic scale 1. A scroll-up button 32a and a scroll-down button 32b are arranged to be adjacent to the setting button 34. The display 33 is responsive to depression of the setting button 34 as personal data (i.e. height) is inputted. After the required measurement is finished, the weight thus measured is displayed on display 33. Display 33 is composed of a LCD window or the like.

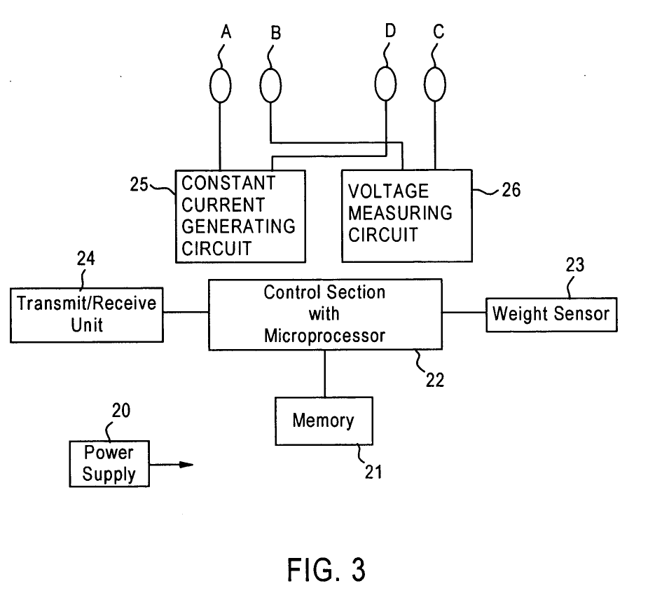

FIG. 2b. depicts a conventional electronic scale 1 further including electrodes A, B, C and D that are used in measuring bioelectrical impedance, in which the present invention can be embodied. Electrodes A, B, C and D are arranged to make two pairs. Each of one pair of electrodes A and D is connected to a constant current generating circuit to serve as a current supply electrode. Each of the other pair of electrodes B and C is connected to a voltage measuring circuit to serve as a voltage measuring electrode (FIG. 3).

FIG. 3 is a block diagram of a control circuit of the scale 1 shown in FIG. 2b. A power supply circuit 20 is connected to a control section 22 having a microprocessor, memory 21 and others therein. The control section 22 is connected with a weight sensor 23 for electrically converting weight or the like, and with an infrared ray transmit/receive unit 24 for communicating the data with the display section. The four electrodes A, B, C and D are paired up in one pair of electrodes A and D connected to the constant current generating circuit 25 and the other pair of electrodes B and C connected to the voltage measuring circuit 26. The control section 22 is connected with the constant current generating circuit 25 and the voltage measuring circuit 26 which are connected to the four electrodes. A conventional control circuit for the display (not shown) includes a control section that is connected with a power supply, an infrared transmit/receive unit for transmitting and receiving the data, an operation section (composed of the above scroll-up button 32a, scroll-down button 32b, setting button 34 and the like) and a display section.

In other embodiments of the present invention, the inventive electronic scale has reference data stored in its memory for a given user profile (example: male, 45 years old, small frame, 5′10″ tall, non-athletic). The scale provides reference values for BIA, BMI, weight, hydration, muscle mass, bone mass, etc. or any combination or single entity listed. Thus, health and fitness profile monitoring is accomplished through target body fat, target body mass, target calorie burn, target hydration levels, etc. As described above, the inventive scale performs the sensing and calculations described herein electronically using conventional hardware such as, for example, a load cell, electrodes, a microprocessor (including circuitry for weight calculation, body fat calculation, etc.) and an addressable memory device.

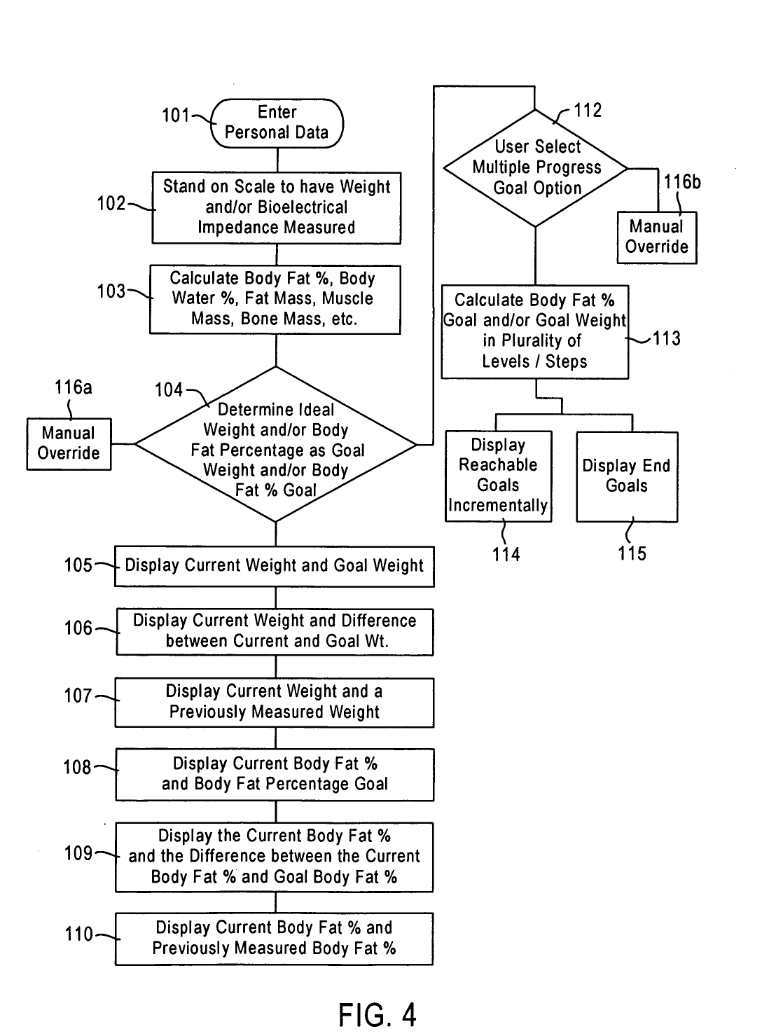

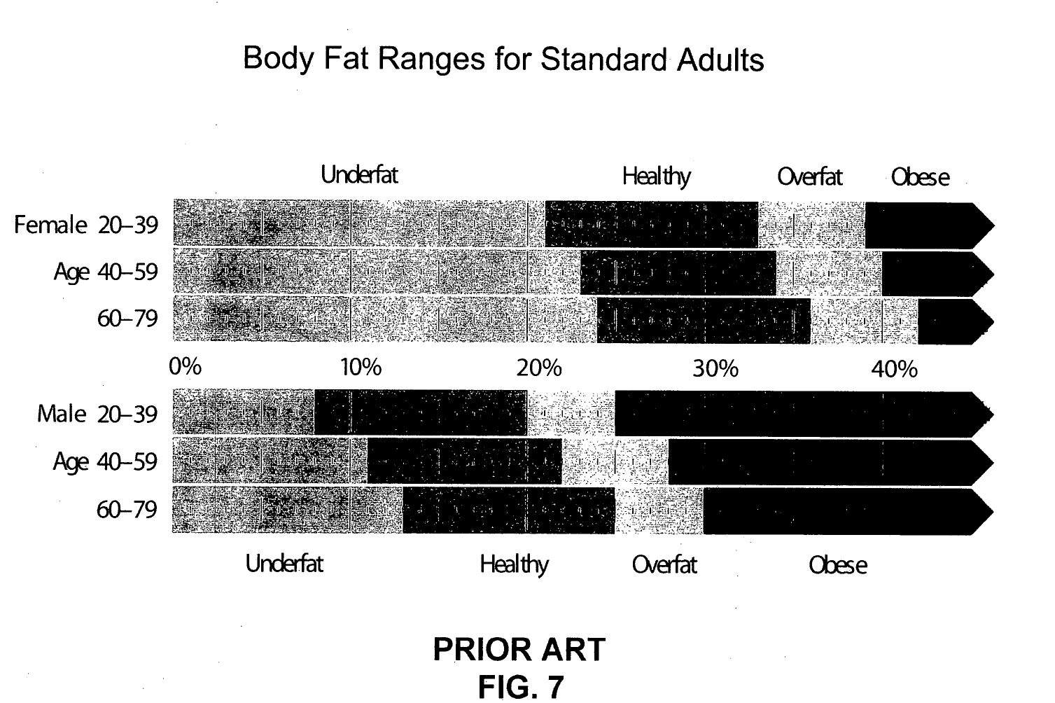

According to one embodiment of the present invention, as illustrated in the block diagram of FIG. 4, the user first enters, personal data (Step 101) such as gender, age, height, race, etc. The user then steps on the scale (Step 102), which measures the user's weight and/or bioelectrical impedance using conventional hardware. The scale's processor can then determine body fat percentage, body water percentage, fat mass, muscle mass, bone mass, etc. in a conventional manner (e.g., weight=fat+muscle mass+bone mass) (Step 103). Tables, such as shown in FIG. 7, are based on research are stored in the scale's memory which determine acceptable ranges for certain parameters (such as body fat percentage and weight) based on age, gender, fitness level, height, race, etc.

In certain embodiments of the present invention, the user can choose to have their ideal weight and/or body fat percentage determined by the inventive scale, as a goal weight and/or goal fat percentage (Step 104). The user can opt out and select their own goal weight and/or goal fat percentage with a manual override (Step 116a). The scale then cycles, either manually or automatically, between displaying the current weight and goal weight (Step 105), the current weight and the difference between the current weight and the goal weight (Step 106), the current weight and the last previously measured weight (Step 107), the current fat and goal fat (Step 108), the current fat and difference between current fat and goal fat (Step 109), and the current fat and last previously measured fat (Step 110).

In another embodiment of the present invention, as shown in FIG. 4, the user can opt for a “multiple progress goal function” (Step 112) which determines the user's weight and/or body fat goals in a plurality of levels or steps based on the stored tables, and displays them per the user's preference. As a non-limiting example, a “Goal 1” represents the outer ends of the healthy range (i.e. for a body fat percentage, “Goal 2” represents a healthier stage range, and “Goal 3” represents an optimal range. The user can choose to display reachable goals incrementally (Step 114) or choose to display only their end goal (Step 115). In either of the embodiments of FIG. 4, the user can manually override the table-based goal setting function and set their own goals as desired (Step 116b).

In a further embodiment of the present invention, the scale calculates and displays a recommended caloric intake based on the user goal data. In this embodiment, tables based on research and stored in the scale's memory determine acceptable ranges for caloric intake based on appropriate user data entered and/or calculated. Thus, the scale can provide the user a guide to achieving their goals (e.g., weight gain or loss).

In all the embodiments of the present invention described herein, the inventive scale stores personal data for a plurality of users. The user selects their own personal data set by pressing button 31a, 31b, 31c or 31d, as shown in FIGS. 2a and 2b. Alternatively, the inventive scale can include a voice-activated user identification system using conventional hardware.

In other embodiments, the present invention downloads information to the scale's memory relating to other bodily parameters, such as caloric intake, pulse, blood pressure, blood oxygen, etc., and/or uploads this and other information into a computer in a conventional manner. An output port is operatively connected to a processor, wherein the processor is for downloading the bodily parameters to an external computer using the output port in a conventional manner.

Some scale users do not wish to have their current weight or goal weight displayed. Therefore, in certain embodiments, the inventive electronic scale will display a user's change in weight relative to their goal weight without displaying the user's current weight or goal weight.

The user first enters personal data such as height, similar to that illustrated in FIG. 4. The user then steps on the scale, which measures the user's weight using conventional hardware and stores it as an initial weight. Tables based on body mass index (BMI) research are stored in the scale's memory which determine acceptable values for weight based on height. The inventive electronic scale has reference data stored in its memory for a given user profile. The scale provides reference values for weight to accomplish health and fitness monitoring through target body weight. As described previously, the user can choose to have their ideal weight determined by the inventive scale as a “goal weight”, or the user can manually override the table-based goal setting function and set their own goal weight as desired. The scale then calculates the difference between the initial weight and the goal weight, and divides it into a number of equal steps (e.g., four steps). The user then selects a display mode: either a “Classic” mode where their weight is displayed, or a “Weightless” mode.

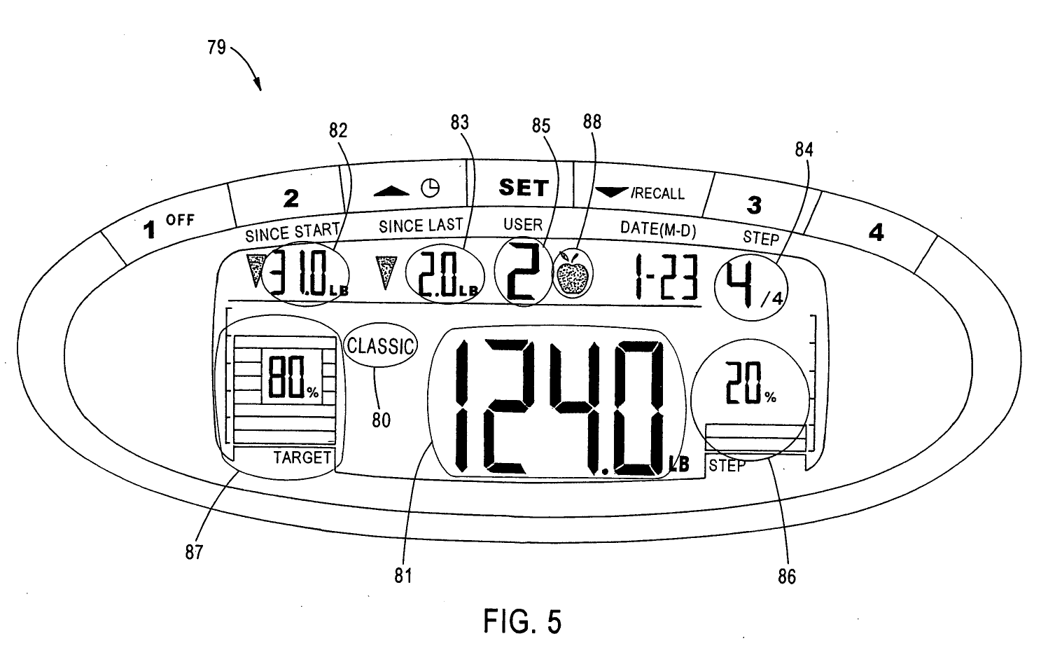

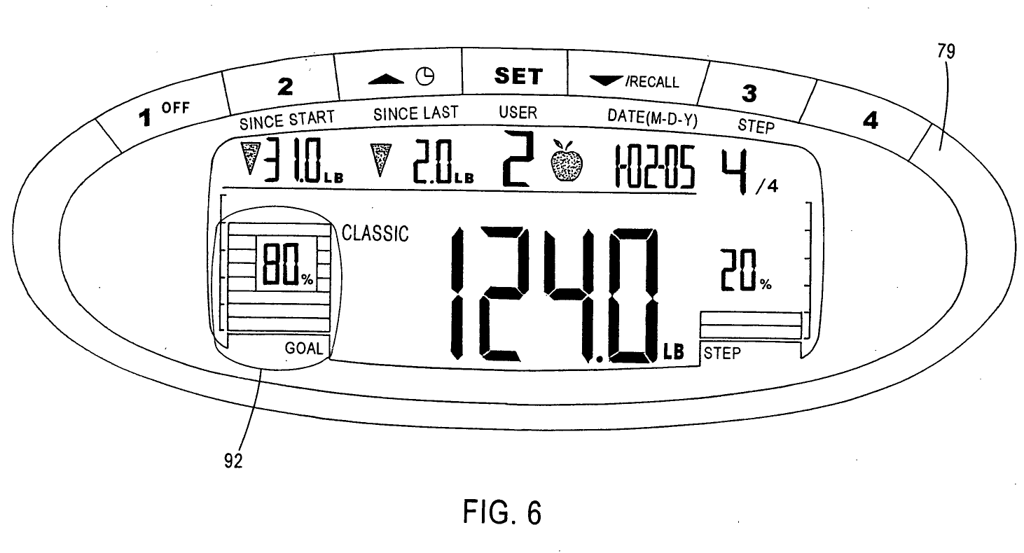

In the classic mode 80, when the user steps on the scale the next time and subsequent times, the scale displays the current weight 81 in large numerals in the middle of display 79, as depicted in FIG. 5. Moreover, as shown in FIG. 5, the display 79 shows the difference between the current weight and the initial weight 82 (labeled “SINCE START”); the difference between the current weight and the weight the last time the user stepped on the scale 83 (labeled “SINCE LAST”); and the number of steps 84 the user 85 has achieved (labeled “STEP” and shown as a fraction such as “¼”, “ 2/4” “¾” or “ 4/4”). The percentage achieved towards the next step 86 (labeled “STEP” and shown graphically and numerically) and the percentage achieved towards a target goal weight 87 (labeled “TARGET” and shown graphically and numerically) are also displayed. In an alternative embodiment, the percentage achieved towards a total goal weight 92 (labeled “GOAL” and shown graphically and numerically) is shown in display 79 in FIG. 6.

In weightless mode (not shown), the current weight 81 is not displayed since some users prefer not to have their current weight or goal weight displayed. Rather, the “SINCE START” 82 and “SINCE LAST” 83 weights are alternately displayed in the display 79. The weightless mode displays are otherwise the same as in the classic mode.

In either Classic or Weightless mode, as shown in FIG. 5, the inventive scale has a benefit icon 88 in the shape of an apple which appears on display 79 when the user achieves a predetermined percentage of their goal; e.g., 5% of their goal. Upon the completion of one step, the word “GOAL” (not shown) is displayed in the center of the display alternating with the current weight. When the user has reached their goal, a reward icon “GOAL” appears in the center of the display alternating with their current weight.

In another embodiment of the present invention, the inventive scale has a body fat meter and reference data stored in its memory for a given user profile (example: male, 45 years old, small frame, 5′10″ tall, non-athletic. The scale provides reference values for BIA, BMI, weight, hydration, muscle mass, bone mass, etc. or any combination or single entity listed. Thus, health and fitness profile monitoring is accomplished through target body fat, target body mass, target calorie burn, target hydration levels, etc.

As in the previous embodiments, the user first enters personal data such as gender, age, height, race, etc. The user then steps on the scale, which measures the user's weight and bioelectrical impedance using conventional hardware. The scale's processor can then determine body fat percentage, body water percentage, fat mass, muscle mass, bone mass, etc. in a conventional manner (e.g., weight=fat+muscle mass+bone mass). Tables based on research are stored in the scale's memory which determine acceptable ranges for certain parameters (such as body fat percentage and weight) based on age, gender, fitness level, height, race, etc. In one embodiment of the present invention, the user can choose to have their ideal weight and/or body fat percentage determined by the inventive scale, as a goal weight and/or goal fat percentage. The user can manually override the table-based goal setting function and set their own goals as desired.

In a “Classic” display mode selected by the user, the scale then cycles, either manually or automatically, between displaying the current weight and goal weight; the current weight and the difference between the current weight and the goal weight; the current weight and the last previously measured weight; the current body fat percentage and goal body fat percentage; the current body fat percentage and the difference between the current body fat percentage and goal body fat percentage; and the current body fat percentage and last previously measured body fat percentage. In a “Weightless” display mode selected by the user, the scale does not display the current weight or current body fat percentage.

In other embodiments of the present invention, the user can opt for a “multiple progress goal function” which determines the user's weight and/or body fat goals in a plurality of levels or steps based on the stored tables, and displays them per the user's preference, similar to the block diagram of FIG. 4.

In further embodiments, the inventive scale is a baby scale, such as a neo-natal scale for use by medical service professionals (e.g., pediatric offices or pediatric wards of hospitals), or for use by consumers, to measure development of newborns or infants. In this embodiment, medical guidelines for newborn development based on age are stored in the scale's memory, and the scale provides goals for weight gain. Such goals are based on published data from clinical studies, and advise parents and/or medical professionals of healthy developmental progress. In certain embodiments of the present invention, a length measuring device is included, so length can be readily measured with weight to improve accuracy.

In still further embodiments of the present invention, conventional wireless communication technology, such as Bluetooth technology, is used to communicate progress and user data from the inventive scale to a hand held device such as a PDA, laptop computer, cellular phone, etc. The collected data can then be sent to professional weight management services, either at the home or in the business location of the service provider (e.g., Weight Watchers®, Jenny Craig®, etc.), thereby allowing weight gain/loss monitoring at the user's home. The data can also be transmitted to a physician, medical clinic, pediatric office, etc. for health monitoring purposes. This feature of the present invention facilitates controlling health care costs in the treatment of patients recovering at home from serious illnesses, such as heart disease, that require weight gain/loss monitoring. In certain other embodiments of the present invention, a professional service or a physician sets the weight gain/loss goals for the user by wireless communication with the inventive scale, which is equipped with the appropriate conventional transceiver. Thus, in this embodiment of the present invention, the inventive scale, the user and the health professional are interactive.

The present invention can be practiced by employing conventional materials, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding of the present invention. However, it should be recognized that the present invention can be practiced without resorting to the details specifically set forth. In other instances, well known processing structures have not been described in detail, in order not to unnecessarily obscure the present invention.

Only a few embodiments of the present invention and but a few examples of its versatility are shown and described in the present disclosure. It is to be understood that the present invention is capable of use in various other combinations and environments and is capable of changes or modifications within the scope of the inventive concept as expressed herein.

1. A scale comprising:
a platform for supporting the weight of a user;
a load cell for receiving the weight of the user when the user steps on the platform, and for generating a signal responsive to the weight of the user;
a processor for calculating a current weight of the user responsive to the signal from the load cell;
an input unit operatively connected to the processor for manually entering a goal weight; and
a display unit operatively connected to the processor;
wherein the processor is for storing the goal weight and the current weight and for causing the display unit to display a difference between the current weight and the goal weight.

2. A scale comprising:
a platform for supporting the weight of a user;
a load cell for receiving the weight of the user when the user steps on the platform, and for generating a signal responsive to the weight of the user;
a processor for calculating a current weight of the user responsive to the signal from the load cell;
an input unit operatively connected to the processor for manually entering a goal weight; and
a display unit operatively connected to the processor;
wherein the processor is for calculating the difference between the stored current weight and the goal weight, and causing the display unit to display the difference between the current weight and the goal weight without displaying the current weight or goal weight of the user.

3. The scale of claim 2, wherein the processor is for storing the current weight as a previous weight when the user steps off the platform, and for causing the display unit to display the difference between the previous weight and an updated current weight when the user subsequently steps on the platform.

4. The scale of claim 3, wherein the processor is for causing the display unit to display a comparison of the goal weight, the previous weight, and the difference between the goal weight and the current weight without displaying the current weight or goal weight of the user.

5. The scale of claim 1, further comprising a memory device for storing reference data relating suggested goal weights to personal data;
wherein the input unit is for entering personal data of the user;
wherein the processor is for determining a suggested goal weight for the user based on the reference data and the personal data of the user; and
wherein the processor is for storing the determined suggested goal weight as the goal weight when the user does not enter the goal weight using the input unit.

6. The scale of claim 5, wherein the processor is for storing the current weight as an initial weight, for calculating a difference between the initial weight and the goal weight, and for dividing the difference into a plurality of equal steps; and
wherein when the user steps off the platform and subsequently steps on the platform, the processor is for calculating and causing the display unit to display an updated current weight; and at least one of a percentage achieved towards the goal weight, the number of the steps the user has achieved, and the percentage achieved towards the next one of the steps responsive to the updated current weight; or alternately,
wherein when the user steps off the platform and subsequently steps on the platform, the processor is for calculating and causing the display unit to display the difference between the updated current weight and the initial weight and the difference between the updated current weight and a last previous weight; and at least one of a percentage achieved towards the goal weight, the number of the steps the user has achieved, and the percentage achieved towards the next one of the steps responsive to the updated current weight.

7. The scale of claim 5, further comprising a bioelectrical impedance measuring device for measuring a bioelectrical impedance of the user when the user steps on the scale,
wherein the processor is for calculating a current body fat percentage of the user based on the measured bioelectrical impedance;
wherein the reference data stored in the memory device includes data relating suggested goal body fat percentages to the personal data;
wherein the processor is for determining a suggested goal body fat percentage based on the reference data and the personal data of the user, and for storing the determined suggested goal body fat percentage as a goal body fat percentage.

8. The scale of claim 7, wherein the processor is for calculating a difference between the current body fat percentage and the goal body fat percentage, and causing the display unit to display the difference between the current body fat percentage and the goal body fat percentage without displaying the current body fat percentage or current weight.

9. The scale of claim 5, wherein the reference data stored in the memory device includes data relating ranges of caloric intake to personal data; and
wherein the processor is for determining a recommended caloric intake based on the reference data, the personal data of the user and the goal weight.

10. The scale of claim 1, wherein the input unit comprises a voice-activated user identification device.

11. The scale of claim 1, wherein the input unit is for entering bodily parameters of the user for storage in the memory unit or processor.

12. The scale of claim 11, comprising an output port operatively connected to the processor, wherein the processor is for downloading the bodily parameters to an external computer using the output port.

13. The scale of claim 11, wherein the bodily parameters comprise at least one of caloric intake, pulse, blood pressure and blood oxygen.

14. The scale of claim 5, wherein the processor is for causing the display unit to display:
a benefit icon when the user achieves either a predetermined percentage of their goal weight or completes one or more steps; and/or
a reward icon when the goal weight of the user is achieved.

15. The scale of claim 1, wherein the scale further comprises:
a memory device for storing reference data related to medical guidelines for newborn or infant development; and
an optional length measuring device.

16. The scale of claim 1, wherein the scale further comprises:
wireless communication hardware for transmitting user data to a remote health care provider and for receiving data and/or instructions from the health care provider.

17. A scale comprising:
a platform for supporting the weight of a user;
a load cell for receiving the weight of the user when the user steps on the platform, and for generating a signal responsive to the weight of the user;
a processor for calculating a current weight of the user responsive to the signal from the load cell;
an input unit operatively connected to the processor for manually entering a goal weight; and
a display unit operatively connected to the processor;
wherein the processor is for storing the goal weight and the current weight and for causing the display unit to display the stored goal weight and the current weight.

18. The scale of claim 17, wherein the processor is for calculating a difference between the current weight and the goal weight, and causing the display unit to display the difference between the current weight and the goal weight.

19. The scale of claim 18, wherein the processor is for storing the current weight as a previous weight when the user steps off the platform, and for causing the display unit to display the previous weight and an updated current weight when the user subsequently steps on the platform.

20. The scale of claim 19, wherein the processor is for causing the display unit to display the current weight while alternately displaying the goal weight, the previous weight, and the difference between the goal weight and the current weight when the user subsequently steps on the platform.

21. The scale of claim 17, further comprising a memory device for storing reference data relating suggested goal weights to personal data;
wherein the input unit is for entering personal data of the user;
wherein the processor is for determining a suggested goal weight for the user based on the reference data and the personal data of the user; and
wherein the processor is for storing the determined suggested goal weight as the goal weight when the user does not enter the goal weight using the input unit.

22. The scale of claim 21, further comprising a bioelectrical impedance measuring device for measuring a bioelectrical impedance of the user when the user steps on the scale,
wherein the processor is for calculating a current body fat percentage of the user based on the measured bioelectrical impedance;
wherein the reference data stored in the memory device includes data relating suggested goal body fat percentages to the personal data;
wherein the processor is for determining a suggested goal body fat percentage based on the reference data and the personal data of the user, and for storing the determined suggested goal body fat percentage as a goal body fat percentage; and
wherein the processor is for causing the display unit to display the current body fat percentage and the goal body fat percentage.

23. The scale of claim 22, wherein the input unit is for manually entering a body fat percentage chosen by the user, and the processor is for storing the manually entered body fat percentage as the goal body fat percentage.

24. The scale of claim 22, wherein the processor is for calculating at least one of a body water percentage, fat mass, bone mass, and muscle mass of the user based on the measured bioelectrical impedance, and for causing the display unit to display the calculated values.

25. The scale of claim 23, wherein the processor is for calculating a difference between the current body fat percentage and the goal body fat percentage, and causing the display unit to display the difference between the current body fat percentage and the goal body fat percentage.

26. The scale of claim 25, wherein the processor is for storing the current body fat percentage as a previous body fat percentage when the user steps off the platform, and for causing the display unit to display the previous body fat percentage and an updated current body fat percentage when the user subsequently steps on the platform.

27. The scale of claim 26, wherein the processor is for causing the display unit to display the current body fat percentage while alternately displaying the goal body fat percentage, the previous body fat percentage, and the difference between the goal body fat percentage and the current body fat percentage when the user subsequently steps on the platform.

28. The scale of claim 22, wherein the processor is for determining the suggested goal body fat percentage as a plurality of steps based on the reference data and the personal data of the user, and for enabling the user to choose one of the steps as the goal body fat percentage.

29. The scale of claim 28, wherein each of the steps corresponds to a relative health range.

30. The scale of claim 21, wherein the processor is for determining the suggested goal weight as a plurality of steps based on the reference data and the personal data of the user, and for enabling the user to choose one of the steps as the goal weight.

31. The scale of claim 30, wherein each of the steps corresponds to a relative health range.

32. The scale of claim 23, wherein the reference data stored in the memory device includes data relating ranges of caloric intake to personal data; and
wherein the processor is for determining a recommended caloric intake based on the reference data, the personal data of the user and the goal weight.

33. The scale of claim 26, wherein the processor is for storing the current and previous weight and body fat percentage, goal weight and body fat percentage, and personal data as discrete data sets for a plurality of users, and the input unit is for selecting one of the data sets.

34. The scale of claim 33, wherein the input unit comprises a voice-activated user identification device.

35. The scale of claim 26, wherein the input unit is for entering bodily parameters of the user for storage in the memory unit or processor.

36. The scale of claim 35, comprising an output port operatively connected to the processor, wherein the processor is for downloading the bodily parameters to an external computer using the output port.

37. The scale of claim 35, wherein the bodily parameters comprise at least one of caloric intake, pulse, blood pressure and blood oxygen.

38. The scale of claim 21, wherein the user personal data includes at least one of age, height and gender.

39. The scale of claim 21, wherein the processor is for storing the current weight as an initial weight, for calculating a difference between the initial weight and the goal weight, and for dividing the difference into a plurality of equal steps; and
wherein when the user steps off the platform and subsequently steps on the platform, the processor is for calculating and causing the display unit to display an updated current weight and at least one of a percentage achieved towards the goal weight, the number of the steps the user has achieved, and the percentage achieved towards the next one of the steps responsive to the updated current weight.

40. The scale of claim 21, wherein the processor is for storing the current weight as an initial weight, for calculating a difference between the initial weight and the goal weight, and for dividing the difference into a plurality of equal steps; and
wherein when the user steps off the platform and subsequently steps on the platform, the processor is for calculating an updated current weight and for calculating and causing the display unit to display at least one of a difference between the updated current weight and the initial weight, a difference between the updated current weight and a weight a percentage achieved towards the goal weight, the number of the steps the user has achieved, and the percentage achieved towards the next one of the steps responsive to the updated current weight.
